(19) United States
(12) Patent Application Publication
(10) Pub. No.: US 2023/0162173 A1
(43) Pub. Date: May 25, 2023

(54) System for Implementing Artificially Intelligent Smart Contract Escrow Service

(71) Applicant: MATTHEW CHARLES JAMES, FAYETTEVILLE, GA (US)

(72) Inventor: MATTHEW CHARLES JAMES, FAYETTEVILLE, GA (US)

(21) Appl. No.: 17/531,967

(22) Filed: Nov. 22, 2021

(51) Int. Cl. G06Q 20/36; G06Q 20/40

(52) U.S. Cl. CPC G06Q 20/3674; G06Q 20/401; G06Q 2220/00

(57) ABSTRACT

The present disclosure provides a system configured to enact an escrow service for transactions between two or more parties, managed by blockchain implemented event-driven artificially intelligent smart contracts. All cryptocurrencies are supported, as well as other assets and services, with specific contract templates provided pre-made for different types of transactions. The funds received from the purchasing party for each managed transaction are locked into a blockchain wallet address created for the specific transaction contract while the two parties enact the transaction, and are only released to the selling party after confirmation and approval from the buying party or after a predetermined amount of time specified in the contract has elapsed.

### FIELD OF INVENTION

The present invention relates generally to the field of distributed ledger technology. More specifically, the present invention relates to a system architecture and set of protocols that make use of artificially intelligent event-driven smart contracts for automated brokering of a transaction between two or more parties.

### BACKGROUND

A blockchain is a computer-implemented decentralized, consensus-based, distributed system made up of blocks which in turn are made up of transactions. Each block contains a hash of the data contained in the previous block which acts as a digital fingerprint so that the blocks become chained together to create a permanent, immutable record of all transactions which have been written to the blockchain since its inception. The most widely known application of blockchain technology is the Bitcoin ledger, however many other blockchain implementations have been proposed and developed. In particular, blockchain infrastructures are uniquely suited to tokenizing assets with digital tokens since the data held in the chain is immutable and tokens cannot be copied or tampered with. These tokens are often labelled cryptocurrencies.

As of 2021 there are over 12,000 cryptocurrencies in existence, however only 6 of those have the capability to integrate smart contracts into their respective systems—the vast majority of these currencies are simply traded between parties as assets.

It is well known that the cryptocurrency trading industry is highly unregulated and fraught with scams, hackers, and other bad actors. Without the appropriate smart contract functionality in place to enact transactions between parties, there is no safeguard for users wishing to trade cryptocurrency assets, or trade assets for services.

It is within this context that the present invention is provided.

### SUMMARY

The present disclosure provides a system configured to enact an escrow service for transactions between two or more parties, managed by blockchain implemented event-driven artificially intelligent smart contracts. All cryptocurrencies are supported, as well as other assets and services, with specific contract templates provided pre-made for different types of transactions.

The funds received from the purchasing party for each managed transaction are locked into a blockchain wallet address created for the specific transaction contract while the two parties enact the transaction, and are only released to the selling party after confirmation and approval from the buying party or after a predetermined amount of time specified in the contract has elapsed.

The system prevents fraud, deception and other unfair trading practices when using digital currency to pre-pay for goods being shipped or services to be rendered.

It should be noted that the term “asset” as used herein is not limited to cryptocurrencies, but can also refer to other types of goods and services. Examples are given in the detailed description section.

It should also be noted that the term “smart contract” as used herein with reference to the smart contract modules of the system of the present disclosure refers not to a standard default smart contract type, but to an artificially intelligent event driven smart contract type which can switch between different protocols based on interactions with third party APIs, thus leading to an event driven escrow service offering.

Thus, according to one aspect of the present disclosure there is provided a system for managing a transaction between two parties, the system comprising: a transaction contract database having stored thereon a plurality of types of transaction contract template having associated template ID numbers and respective source code for managing certain types of transactions; and a front-end interface module configured to generate and host a web page in which a first party wishing to sell an asset and a second party wishing to buy the asset provide respective first and second blockchain wallet addresses, select a contract type from a list of contract types stored in the transaction contract database, and provide their electronic signatures for the contract.

The system further comprises a contract creator module, configured to receive the first blockchain wallet address, second blockchain wallet address, and template ID from the interface module, and to extract the necessary source code for implementing a transaction between the first party and second party from the contract database, and to create a transaction contract and a set of encryption keys using those parameters, and to update the transaction contract with a blockchain wallet address for the transaction after receiving it from a first smart contract module; a first smart contract module hosted by a blockchain network and configured to generate the blockchain wallet address for the transaction, hold an amount of funds received from the second party for the asset of the transaction in the transaction wallet address while awaiting confirmation of the transaction, and to implement the transaction according to a transaction result type received from a second smart contract module; and a second smart contract module hosted by the blockchain network and configured to store and maintain an event history for each transaction managed by the system in a set of arrays and dynamic arrays.

Each of the first smart contract module and second smart contract module are in communication with a set of one or more third party entities and receive event updates relating to transactions managed by the system from the one or more third party entities, the event updates allowing the smart contract modules to determine a transaction result for each transaction and thus determine how the first smart contract implements the transaction.

In some embodiments, each of the first, second, and third blockchain wallet addresses are hosted by the Ethereum blockchain network.

In some embodiments, the first smart contract module and second smart contract module each run on the Ethereum blockchain network.

In some embodiments, if it is determined from the one or more third party entities that the second party acting as the buyer of the asset refused the asset and sent it back, the first smart contract module is configured to unlock the assets received from the second party from the third blockchain wallet address and return them to the second blockchain wallet address.

In some embodiments, if it is determined from the one or more third party entities that the asset was damaged, the first smart contract module is configured to initiate an insurance protocol function for the asset.

In some embodiments, if it is determined from the one or more third party entities that the second party acting as the buyer of the asset accepts the asset and approves the transaction, the first smart contract module is configured unlock the assets received from the second party from the third blockchain wallet address and return them to the first blockchain wallet address.

In some embodiments, the encryption keys generated for the transaction are used to encrypt a transaction web page hosted by the interface module through which the first and second party may take actions relating to the transacted asset, and which is thus accessible only to the first and second parties.

In some embodiments, a media driver function of the first smart contract module generates a subscriber ID using the transaction contract parameters and uses the subscriber ID and an Application Programming Interface, API, to communicate the contract parameters to the one or more third party entities.

In some embodiments, the first smart contract module comprises a listener function which checks the event history maintained by the second smart contract module periodically for event updates relating to the transaction contract.

In some embodiments, each transaction contract has an associated transaction contract ID generated for referencing the transaction contract.

In some embodiments, each event update received from the one or more third party entities has an associated event type, and wherein the second smart contract module is configured to store the event updates in dynamic arrays separated by event type, and wherein the first smart contract module checks the second smart contract module event history for events of certain types relating to a given transaction when implementing the transaction.

### BRIEF DESCRIPTION OF THE DRAWINGS

Various embodiments of the invention are disclosed in the following detailed description and accompanying drawings.

FIG. 1 illustrates a front end interface and contract creation module of an example system architecture for a smart contract-based escrow service according to the present disclosure.

FIG. 2 illustrates a first smart contract module of the example system architecture for a smart contract-based escrow service according to the present disclosure.

FIG. 3 illustrates a second smart contract module of the example system architecture for a smart contract-based escrow service according to the present disclosure.

FIG. 4 illustrates a flow diagram of an example set of steps carried out by the escrow service system of the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a trusted digital escrow service to use during the peer-to-peer exchange of goods or services which are paid for, in whole or part, with cryptocurrency, virtual currency or other digital or real assets or services. Examples of the types of transactions that can be managed by the disclosed digital escrow system include but are not limited to: banking, intellectual property, real estate, legal services, mergers and acquisitions, and any other type of good or service transaction traditionally managed by escrow services.

By default, smart contracts have no mechanism for updating themselves or taking into consideration actions that occur while the contract is in effect—they merely carry out pre-programmed operations according to their own algorithms.

In contrast, the smart contract modules of the present disclosure as described below act as event-driven intelligent agents. In artificial intelligence, an intelligent agent (IA) is anything which perceives its environment, takes actions autonomously in order to achieve goals, and may improve its performance with learning or may use knowledge. They may be simple or complex—a thermostat is considered an example of an intelligent agent, as is a human being, as is any system that meets the definition, such as a firm, a state, or a biome.

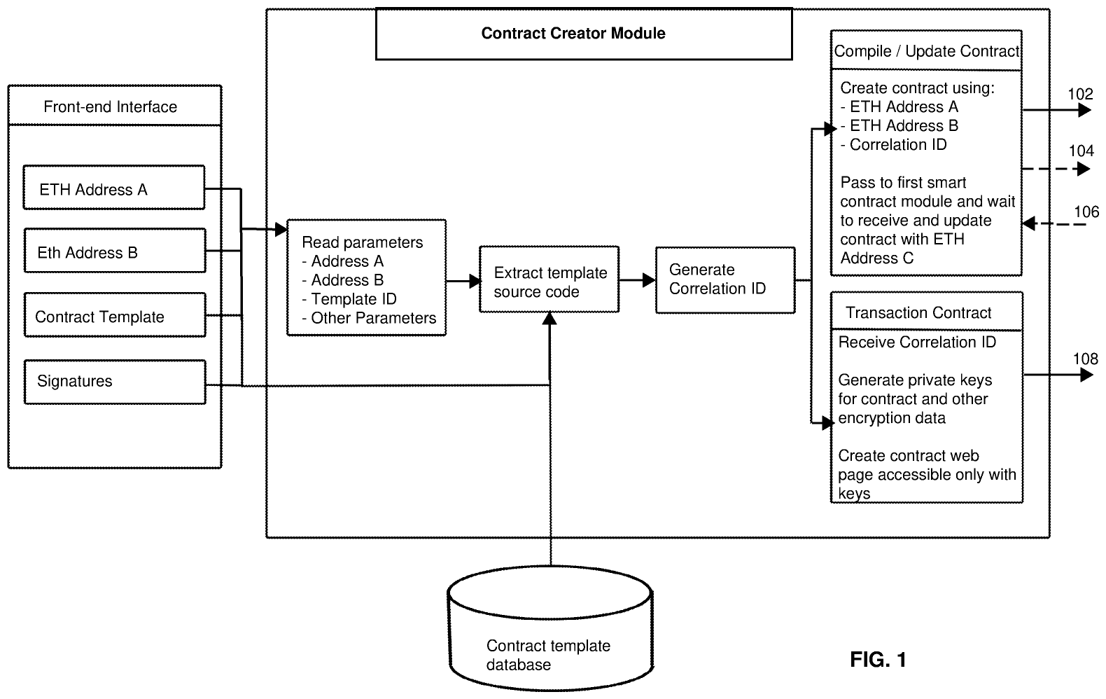

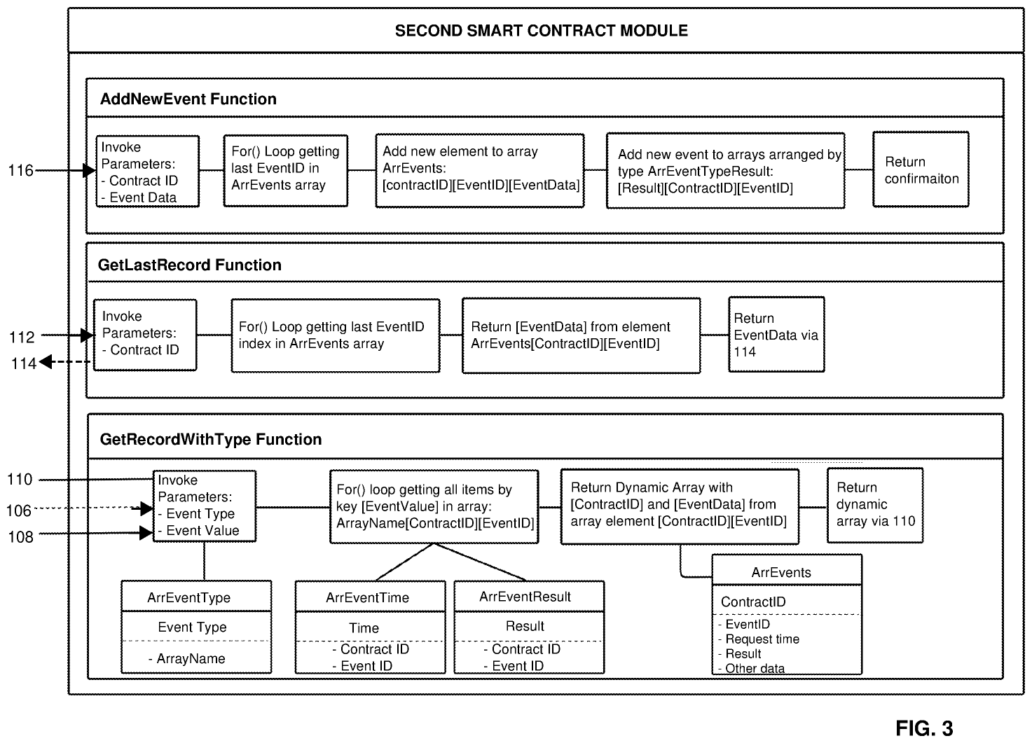

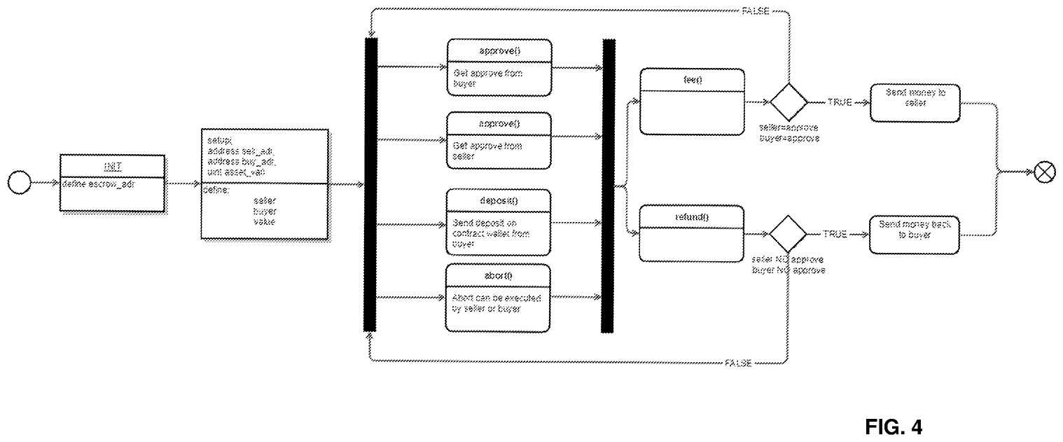

Referring to FIGS. 1-4, an example system architecture for a smart contract-based escrow service according to the present disclosure. The connections between the various modules of the system architecture are shown by reference numerals 102, 104, 106, 108, 110, 112, 114, and 116.

In FIG. 1, a front end interface and contract creation module of the system are depicted.

The example system comprises a contract template database which houses a number of different smart contract templates for different situations, each having an associated template ID and source code for carrying out appropriate operations for a type of transaction. The contract template database may be hosted on a blockchain network for security purposes.

The example system also comprises a front-end interface module configured to generate and host a web page where a first party Party A (having associated ETH address A) who wishes to sell an asset or service and a second Party B (having an associated ETH address B) who wishes to buy the asset or service may select a suitable contract template from a list of available contract types and sign it to initialise a set of smart contract modules implemented by the system.

The front-end interface module passes the parameters of the contract to a contract creator module which receives at least the ETH Address A and ETH Address B, the contract parameters, and a template ID identifying the contract type selected. The contract creator module then extracts the necessary source code for the contract type and uses the parameters to generate a correlation ID.

The contract creator module then uses the Correlation ID to compile a transaction contract with the Party A and Party B wallet addresses, contract source code, and the correlation ID and contract ID. Once the contract is created the creator module waits to receive a transaction contract wallet ETH address for the transaction and, when received, uses it to update the transaction contract.

Private encryption keys and other sensitive data are generated for the transaction contract at this point also. This transaction contract can be accessed via a contract web page accessible only by party A and party B who have the encryption keys, they can each use this web page for committing confirmations for the contract and possible for other operations.

Once an ETH address is generated for the Transaction contract by the first smart module, the contract creator module updates and finalizes the Transaction contract for the transaction and forwards Is parameters to the second smart contract.

The system comprises two smart contract modules: one for generating the transaction wallet address and implementing the transaction by managing funds, and a second for storing and maintaining an event history for the various transactions managed by the system according to event updates received by third party entities.

The first smart contract module, which in the present example is run as a side chain interacting with the Ethereum blockchain network (a system architecture well known to those skilled in the art) and is responsible for generating an ETH address and implementing the Transaction contract for the transaction using the created address, receives as inputs for each transaction contract: a Contract ID and a set of contract logic.

It should be noted that while the description of the present disclosure uses Ethereum side chains as an example infrastructure which can support the disclosed digital escrow system, the principles taught herein can be applied in and adapted to various other distributed ledger technology structures.

After receiving the transaction contract parameters from the contract creation module the first smart contract module creates a corresponding wallet on the Ethereum blockchain (ETH Address C) and pulls funds from the buyer's ETH address B to hold under lock while the transaction is implemented.

In the present example the first smart contract module then initializes a Listener Function, API, and MediaDriver function.

The MediaDriver takes the ContractID, CorrelationID, and encryption keys from the Transaction contract and generates a Subscriber ID which is passed to a Subscriber Module and Scheduler Module which in turn allow the system to communicate the contract parameters to third party entities involved in the smart contracts, i.e. providers of goods and services and platform hosts such as DHL, Amazon, and Cryptocurrency Coin Exchanges.

Updates from the third party entities are passed to the second smart contract module and the Listener/API Function regularly checks and receives event updates from the second smart contract module.

Once the listener function is initiated a Requestor/Event Checker function is called which determines how the Transaction contract will be implemented based on the returned events (determined by communication with the third-party entities and the second smart contract module). The Requestor function checks events relating to the Transaction contract by type by communication with the second smart contract module.

As already mentioned, the second smart contract module is configured to maintain event data for each transaction contract managed by the system, the event data received from the third-party entities.

The second smart contract module does this using a set of arrays comprising event data related to the Transaction contract IDs received from the contract creator module. The second smart contract module is specifically programmed for three types of operations:

[1]—Add new event: In this operation, the second smart contract module receives an update from one of the third party entities via the subscriber module and over a Hyperledger network. The update comprises a Contract ID and Event data of the relevant Transaction Contract to which the event pertains.

The second smart contract module obtains the last Event ID relating to that contract in a stored Event array through a for( ) loop function.

A new element is then added to the Event array including the contract ID, the event ID, and the event Data from the update.

A type is then assigned to the event which is also stored in the array and the second smart contract module sends a confirmation once complete.

[2]—GetLastRecord: In this operation, the second smart contract module receives an update request from the Listener/API function of the first smart contract for a specific Contract ID.

The second smart contract module obtains the last Event ID relating to that contract in the stored Event array through a for( ) loop function.

The smart contract then returns all of the data stored in the array relating to the last event for that contract ID to the first smart contract, which in turn will determine if anything has changed since the last check.

[3]—GetAIRecordWithType: In this operation, the smart contract receives a request from the first smart contract module for events of a given type relating to the transaction contract.

Each event update received from the one or more third party entities has an associated event type, and the second smart contract module is configured to store the event updates in dynamic arrays separated by event type.

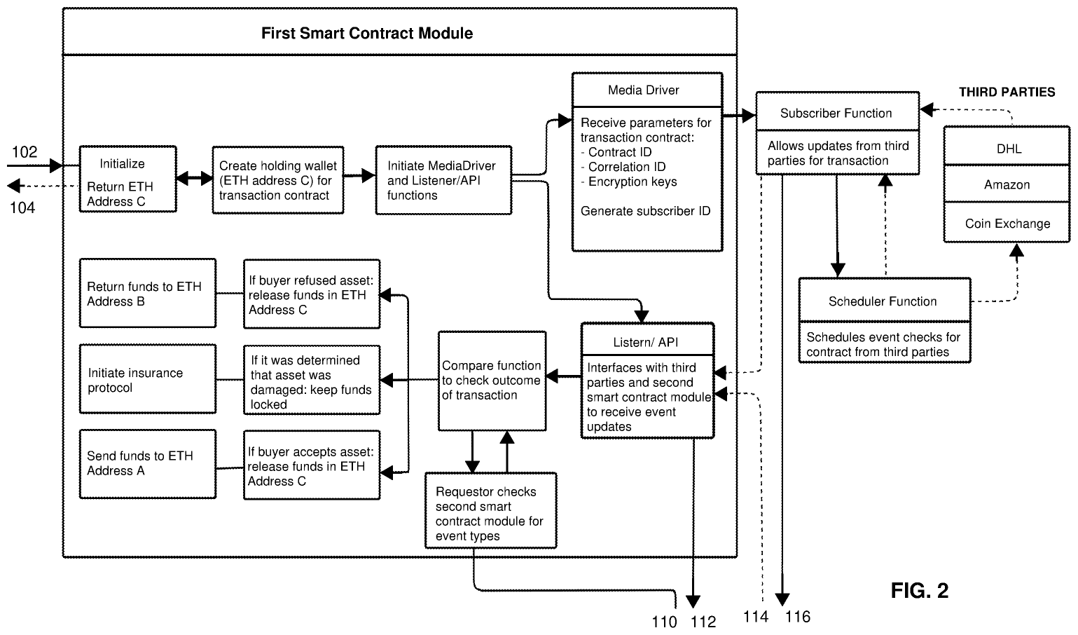

The second smart contract module can thus call for an array of a certain event type according to the request. All items in the array are pulled by a for( ) loop function, and a dynamic array containing the event type details for the transaction contract is returned to the first smart contract module, allowing it to determine the outcome of the transaction and allocate the transaction funds accordingly. FIG. 2 illustrates a flow diagram of an example set of steps carried out by the first smart contract module of the escrow service system of the present disclosure based on different transaction types determined for the transaction contract (a similar set of steps is shown for the first smart contract module in the example of FIG. 1).

The release of funds is event-driven, and is autonomously controlled by the smart contract modules when certain conditions are met.

As can be seen, if it is determined from the one or more third party entities that the transaction was not approved, for example if the second party B acting as the buyer of the asset refused the asset and sent it back, the first smart contract module is configured to unlock the assets received from the transaction contract blockchain wallet address (ETH address C) and return them to the second blockchain wallet address B as a refund.

If it is determined from the one or more third party entities that the second party B acting as the buyer of the asset accepts the asset and approves the transaction, the first smart contract module is configured unlock the assets received from the second party B from the transaction contract blockchain wallet address (ETH address C), deduct a fee, and return them to the first blockchain wallet address of party A, ETH address A.

If no event is received for the transaction contract within a predetermined period of time specified within the contract parameters, the system may be configured to release the funds to the seller. For example, after 3 days to review/inspect the merchandise if the buyer has not provided any indication of acceptance or rejecting of the goods then the funds may be released to ETH address B. While not illustrated, other operations may be implemented. For example if it is determined from the one or more third party entities that the asset was damaged, the first smart contract module is configured to initiate an insurance protocol function for the asset.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit)

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the escrow service system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for managing a transaction between two parties, the system comprising:
a transaction contract database having stored thereon a plurality of types of transaction contract template having associated template ID numbers and respective source code for managing certain types of transactions;
a front-end interface module configured to generate and host a web page in which a first party wishing to sell an asset and a second party wishing to buy the asset provide respective first and second blockchain wallet addresses, select a contract type from a list of contract types stored in the transaction contract database, and provide their electronic signatures for the contract;
a contract creator module, configured to receive the first blockchain wallet address, second blockchain wallet address, and template ID from the interface module, and to extract the necessary source code for implementing a transaction between the first party and second party from the contract database, and to create a transaction contract and a set of encryption keys using those parameters, and to update the transaction contract with a blockchain wallet address for the transaction after receiving it from a first smart contract module;
a first smart contract module hosted by a blockchain network and configured to generate the blockchain wallet address for the transaction, hold an amount of funds received from the second party for the asset of the transaction in the transaction wallet address while awaiting confirmation of the transaction, and to implement the transaction according to a transaction result type received from a second smart contract module; and
a second smart contract module hosted by the blockchain network and configured to store and maintain an event history for each transaction managed by the system in a set of arrays and dynamic arrays;
wherein each of the first smart contract module and second smart contract module are in communication with a set of one or more third party entities and receive event updates relating to transactions managed by the system from the one or more third party entities, the event updates allowing the smart contract modules to determine a transaction result for each transaction and thus determine how the first smart contract implements the transaction.

2. A system according to claim 1, wherein each of the first, second, and third blockchain wallet addresses are hosted by the Ethereum blockchain network.

3. A system according to claim 1, wherein the first smart contract module and second smart contract module each run on the Ethereum blockchain network.

4. A system according to claim 1, wherein if it is determined from the one or more third party entities that the second party acting as the buyer of the asset refused the asset and sent it back, the first smart contract module is configured to unlock the assets received from the second party from the third blockchain wallet address and return them to the second blockchain wallet address.

5. A system according to claim 1, wherein if it is determined from the one or more third party entities that the asset was damaged, the first smart contract module is configured to initiate an insurance protocol function for the asset.

6. A system according to claim 1, wherein if it is determined from the one or more third party entities that the second party acting as the buyer of the asset accepts the asset and approves the transaction, the first smart contract module is configured unlock the assets received from the second party from the third blockchain wallet address and return them to the first blockchain wallet address.

7. A system according to claim 1, wherein the encryption keys generated for the transaction are used to encrypt a transaction web page hosted by the interface module through which the first and second party may take actions relating to the transacted asset, and which is thus accessible only to the first and second parties.

8. A system according to claim 1, wherein a media driver function of the first smart contract module generates a subscriber ID using the transaction contract parameters and uses the subscriber ID and an Application Programming Interface, API, to communicate the contract parameters to the one or more third party entities.

9. A system according to claim 1, wherein the first smart contract module comprises a listener function which checks the event history maintained by the second smart contract module periodically for event updates relating to the transaction contract.

10. A system according to claim 1, wherein each transaction contract has an associated transaction contract ID generated for referencing the transaction contract.

11. A system according to claim 1, wherein each event update received from the one or more third party entities has an associated event type, and wherein the second smart contract module is configured to store the event updates in dynamic arrays separated by event type, and wherein the first smart contract module checks the second smart contract module event history for events of certain types relating to a given transaction when implementing the transaction.
